(19) United States
(12) Patent Application Publication
(10) Pub. No.: US 2014/0173170 A1
(43) Pub. Date: Jun. 19, 2014

(54) MULTIPLE SUBARRAY MEMORY ACCESS

(71) Applicant: HEWLETT-PACKARD DEVELOPMENT COMPANY, L.P., Houston, TX (US)

(72) Inventors: Naveen Muralimanohar, Santa Clara, CA (US); Norman P. Jouppi, Palo Alto, CA (US); Rajeev Balasubramonian, Sandy, UT (US); Seth Pugsley, Salt Lake City, UT (US); Niladrish Chatterjee, Salt Lake City, UT (US); Alan Lynn Davis, Coalville, UT (US)

(73) Assignee: Hewlett-Packard Development Company, L.P., Houston, TX (US)

(21) Appl. No.: 13/715,163

(22) Filed: Dec. 14, 2012

(51) Int. Cl. G06F 12/02

(52) U.S. Cl. CPC G06F 12/0238
USPC 711/102

(57) ABSTRACT

A multiple subarray-access memory system is disclosed. The system includes a plurality of memory chips, each including a plurality of subarrays and a memory controller in communication. with the memory chips, the memory controller to receive a memory fetch width (“MFW”) instruction during an operating system start-up and responsive to the MFW instruction to fix a quantity of the subarrays that will be activated in response to memory access requests.

### CROSS-REFERENCE TO RELATED APPLICATIONS

This patent application is related to co-pending U.S. patent application Ser. No. 13/285,735, filed on Oct. 31, 2011, co-pending PCT Patent Application No. PCT/US2011/022,763, filed on Jan. 27, 2011, and U.S. Provisional Patent Application No. 61/299,155, filed on Jan. 28, 2010.

### BACKGROUND

In conventional dynamic random-access memory (“DRAM”) systems, a page of data containing many individual items is fetched in response to a request for one of those items. The fetched page is loaded into a row buffer, and the requested item is then transferred from the buffer to the requestor (typically a CPU). If there is high locality in the access stream (i.e., if the next requested item is likely adjacent to, or near, the previously-requested item), a subsequent request can usually be filled relatively quickly because the subsequent request is probably directed to another item that is within the same page and therefore already in the buffer. But if consecutive requests are directed more or less randomly to various locations in the DRAM, as often happens in modern multi-core servers where multiple threads share a memory controller, a new page of data will have to be fetched for almost every request.

Fetching a page of data into a row buffer is slow and uses energy. In fact, recent studies have found that transferring data to and from memory row buffers consumes a substantial portion of the total energy used by a server. As server farms grow larger, often housing hundreds or even thousands of CPUs, energy usage is becoming a major cost factor and an important environmental consideration. Accordingly, in sonic recently-proposed memory systems only one item of data is fetched in response to a request. Fetching a page of data requires simultaneously activating many chips in a DRAM, whereas fetching only a single item may require activating only one chip, and several different items can be fetched simultaneously by activating several different chips at the same time. This can result in fetching one or several individual items in the same or less time as required for fetching a page and at a much lower energy cost per item accessed.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 is a block diagram of an example of a multiple subarray-access memory system;

FIG. 2 is a block diagram of another example of a multiple subarray-access memory system;

FIG. 3 is a block diagram of an example of a computer system with multiple subarray-access memories;

FIG. 4 is a Hock diagram of another example of a computer system with multiple subarray access memories;

FIG. 5 is a block diagram of another example of a computer system with multiple subarray access memories;

FIG. 6A is a block diagram of another example of a multiple subarray-access memory system;

FIG. 6B is a block diagram showing different features of the example depicted in FIG. 6A;

FIG. 7 is a partial schematic of an example of a memory cell subarray with multiple subarray access including selective activation of portions of rows;

FIG. 8 is a flowchart illustrating an example of a method of accessing a memory with multiple sub-array access; and

FIG. 9 is a flowchart illustrating another example of a method of accessing a memory with multiple sub-array access.

### DETAILED DESCRIPTION

Illustrative examples and details are used in the drawings and in this description, but other configurations may exist and may suggest themselves. Parameters such as voltages, temperatures, dimensions, and component values are approximate. Terms of orientation such as up, down, top, and bottom are used only for convenience to indicate spatial relationships of components with respect to each other, and except as otherwise indicated, orientation with respect to external axes is not critical. For clarity, some known methods and structures have not been described in detail. Methods defined by the claims may comprise steps in addition to those listed, and except as indicated in the claims themselves the steps may be performed in another order than that given.

The systems and methods described herein may be implemented in various forms of hardware, software, firmware, special purpose processors, or a combination thereof. At least a portion thereof may be implemented as an application comprising program instructions that are tangibly embodied on one or more program storage devices such as hard disks, magnetic floppy disks, RAM, ROM, and CDROM, and executable by any device or machine comprising suitable architecture. Some or all of the instructions may be remotely stored; in one example, execution of remotely-accessed instructions may be referred to as cloud computing. Some of the constituent system components and process steps may be implemented in software, and therefore the connections between system modules or the logic flow of method steps may differ depending on the manner in which they are programmed.

As discussed above, fetching a page from memory in response to a request for an item of data works well for data of high locality but wastes time and energy if locality is minimal. On the other hand, fetching only one item in response to a request results in inefficient multiple activations in a critical path when locality is more than zero, increasing the net access time, There is a need for a way to operate computer system memories with minimal access times and minimal energy consumption, especially in modem multi-core servers where locality may change from one application to another,

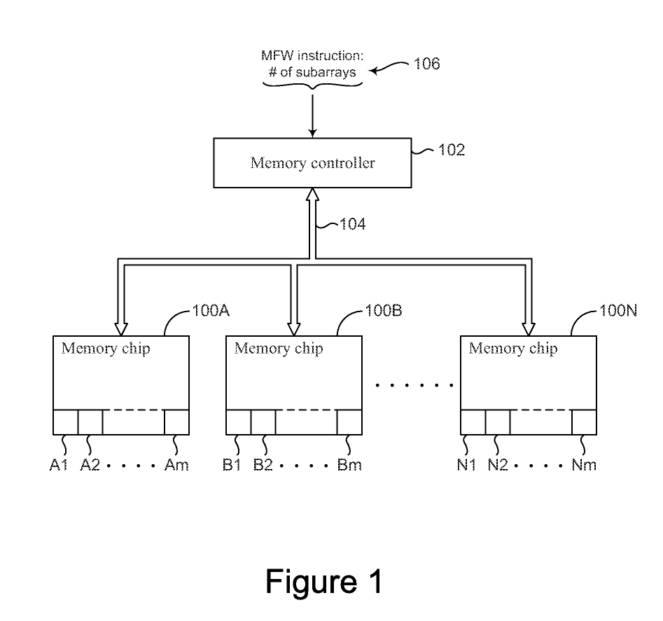

FIG. 1 illustrates an example of a multiple subarray-access memory system. The system includes a plurality of memory chips 100A through 100N. Each memory chip includes a plurality of subarrays. For example, the chip 100A includes subarrays A1 through Am, the chip 100B includes subarrays B1 through Bm, and so on through the chip 100N, which includes subarrays N1 through Nm. The system also includes a memory controller 102 in communication with the memory chips 100A-100N through a bus 104, the memory controller 102 to receive a memory fetch width (“MFW”) instruction 106 during an operating system start-up and responsive to the MFW instruction 106 to fix a quantity of the subarrays that will be activated in response to memory access requests.

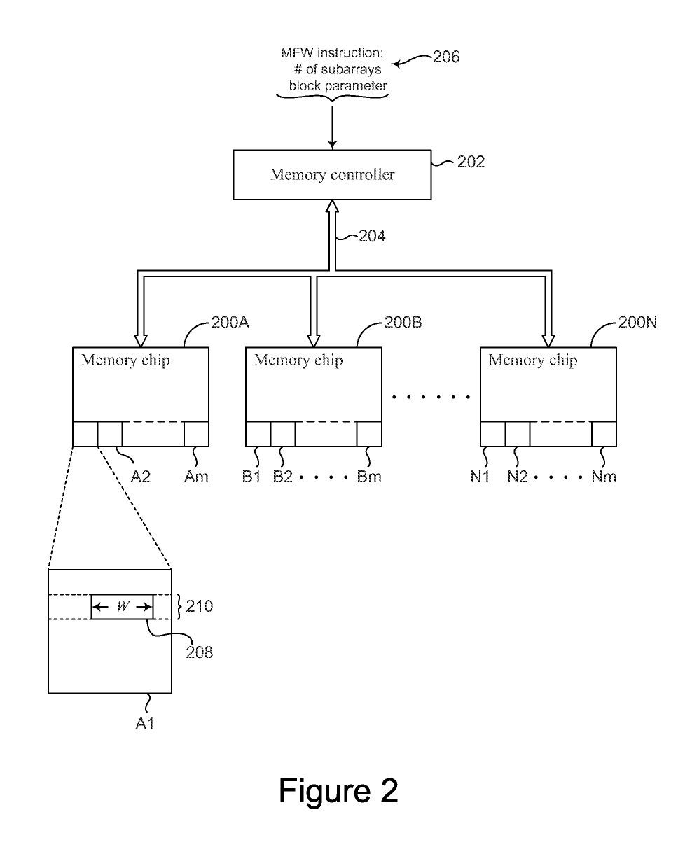

FIG. 2 illustrates another example of a multiple subarray-access memory system. The system includes a plurality of memory chips 200A through 200N. Each memory includes a plurality of subarrays. For example, the chip 200A includes subarrays A1 through Am, the chip 200B includes subarrays B1 through Bm, and so on through the chip 200N, which includes subarrays N1 through Nm. The system includes a memory controller 202 in communication with the memory chips through a bus 204, the memory controller 202 to receive a MFW instruction 206 during an operating system start-up and responsive to the MFW instruction 206 to fix a quantity of the subarrays that will be activated in response to memory access requests. The MFW instruction 206 includes a block parameter, the memory controller 202 responsive to the block parameter to fix a size of a block to be activated within each subarray in response to memory access requests. For example, a block 208 of size W in the memory cell subarray A1 in memory chip 200A comprises part of a row 210 of memory cells in the subarray A1.

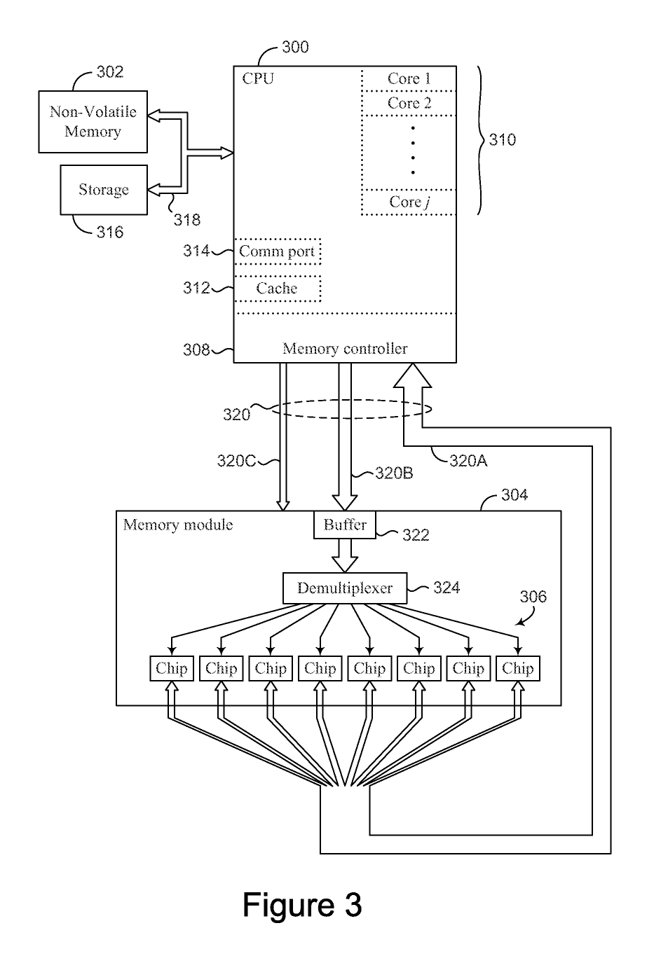

FIG. 3 illustrates an example of a computer system with multiple subarray-access memories. The system includes a central processor unit (“CPU”) 300, a memory 302 (e.g., a non-volatile memory), a memory module 304 containing a plurality of memory chips 306 each including a plurality of subarrays, and a memory controller 308 to receive a memory fetch width (“MFW”) instruction from the memory 302 during start-up of the computer system and responsive to the MFW instruction to fix a quantity of the subarrays that will be accessed in response to memory access requests from the CPU 300.

In the example of FIG. 3, the CPU 300 includes one or more cores 310, a cache memory 312 which may include L1 and L2 caches, and a communication port 314. A storage unit 316, for example a hard disk drive, may be provided. The CPU 300 communicates with the memory 302, the storage unit 316, and other peripheral devices through one or more buses such as a bus 318.

The CPU 300 communicates with the memory module 304 through a bus 320 having 64 data lines 320A, 17 address lines 32013, and 8 control lines 320C. In some examples, communications between the CPU 300, the memory module 304, and any other devices are carried by a single bus rather than the two buses 318 and 320 as shown in FIG. 3. Also, in other examples, a bus may include different numbers of lines for data, address, and control, and in some examples the lines in a bus may be shared rather than dedicated to one function.

In this example, the memory module 304 includes an address buffer 322 that receives an address over the address lines 320B and latches the address for use by the memory module 304. A demultiplexer 324 in communication with the address buffer 322 provides address signals to the memory chips 306. In other examples, the buffer 322 may be omitted, and some other type of logic may be used to provide address signals to the Memory chips 306.

The 64 address lines 320A are divided into eight groups of 8 lines each, one group servicing each of the eight memory chips 306. In other examples, there may be more or fewer than eight memory chips and more or fewer than eight data lines per chip. In some examples, address lines within a bus may be shared by some or all of the chips.

In some examples, operating system instructions are stored in the storage unit 316 and loaded into memory for use by the CPU 300 during system boot-up. In some examples, some or all of the instructions may be remotely stored and communicated to the CPU 300 through the communication port 314. Some examples include instructions that cause the CPU 300 to perform as a virtual machine, and in this case the virtual machine instructions may include an MFW instruction that takes precedence over the MFW instruction that is used at system start,

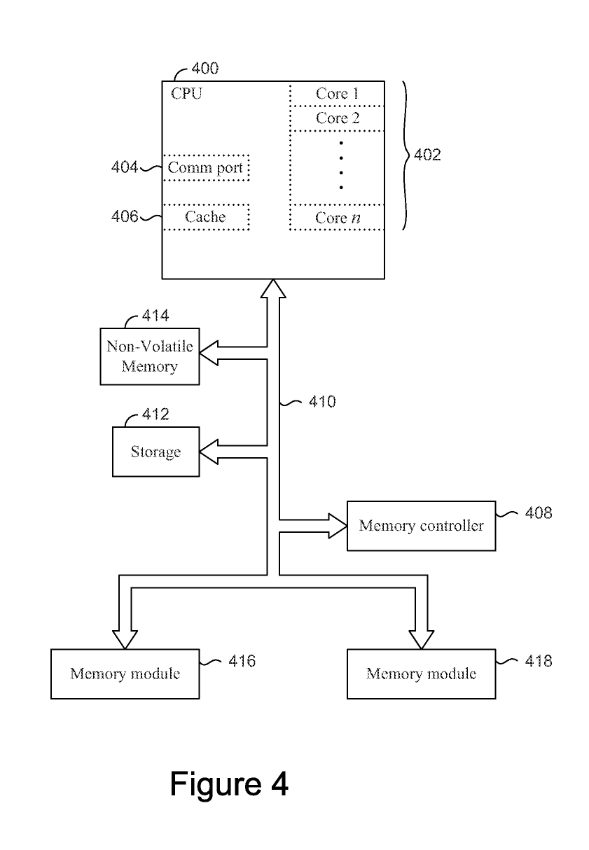

FIG. 4 gives another example of a computer system with multiple subarray-access memories. This example includes a CPU 400 with a plurality of cores 402, a communication port 404, and a cache 406. A memory controller 408, separate from the CPU 400, communicates with the CPU 400 through a bus 410, A storage unit 412 and a memory 414 also communicate with the CPU 400 through the bus 410. The memory controller 408 in turn communicates with a plurality of memory modules 416 and 418 through the bus 410. In some examples, a separate bus may be used for communication between the memory controller 408 and the memory modules 416 and 418.

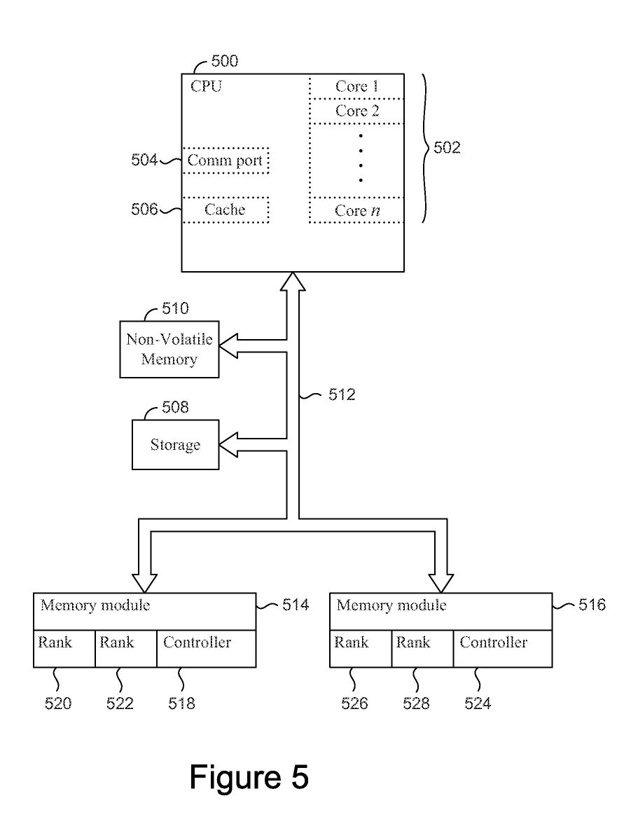

FIG. 5 gives another example of a computer system with multiple subarray-access memories. This example includes a CPU 500 with a plurality of cores 502, a communication port 504, and a cache 506. A storage unit 508 and a memory 510 communicate with the CPU 500 through a bus 512A. plurality of memory modules 514 and 516 also communicate with the CPU 500 through the bus 512. The memory module 514 includes a memory controller 518 and a plurality of memory ranks 520 and 522. Similarly, the memory module 516 includes a memory controller 524 and ranks 526 and 528. In some examples there may be only one, or more than two, memory modules and the modules may have different quantities of ranks.

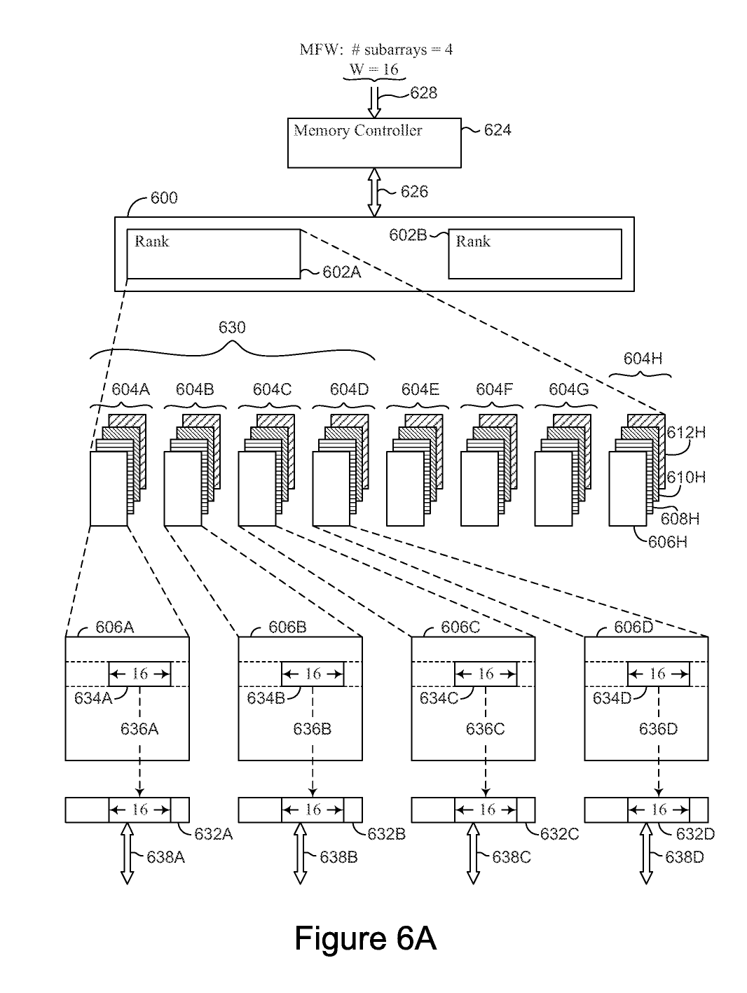

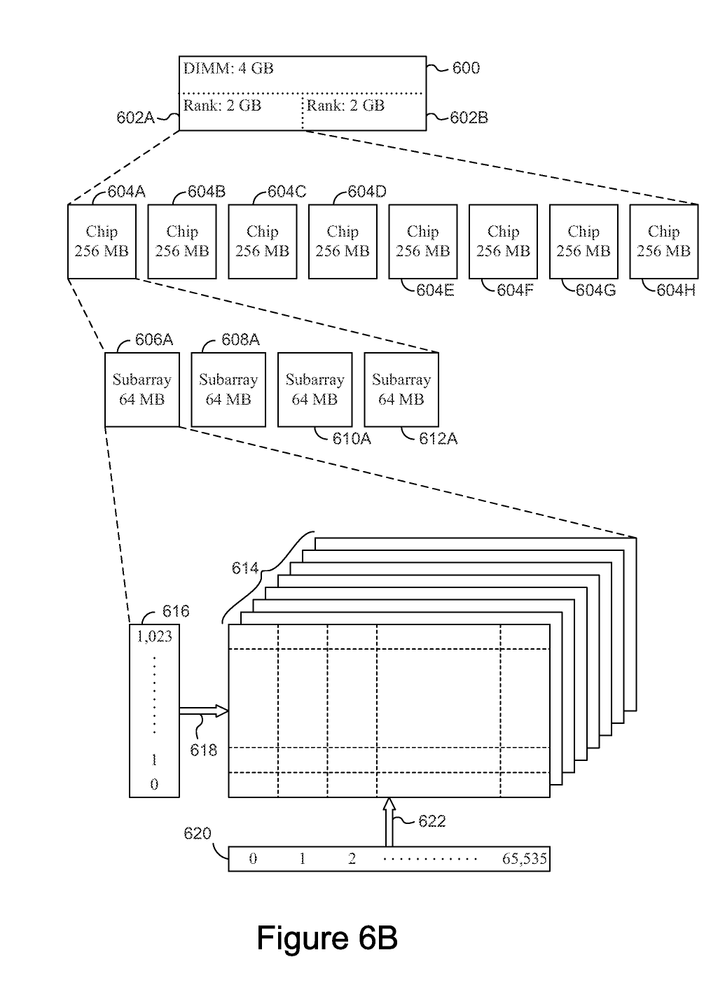

Another example of a multiple subarray-access memory system is shown in FIGS. 6A and 6B. This example depicts a memory system that includes a Dual In-Line Memory Module (“DIMM”) 600. In this example, the DIMM 600 includes two ranks of memory 602A and 602B, each containing 2 Gigabytes (“GB”) of memory; in other examples there may be a different number of ranks, and each rank may contain different amounts of memory.

Each rank may include eight 256 Megabyte (“MB”) chips 604A through 604H. Each chip may include four 64 MB subarrays, For example, the chip 604A may include four subarrays 606A, 608A, 610A and 612A, and so on to the chip 604H, which includes four subarrays 606H, 608H, 610H, and 612H. The subarrays 606A through 606H define a first bank as indicated in FIG. 6A by no shading, the subarrays 608A through 608H define a second bank as indicated by horizontal-line shading, the subarrays 610A through 610H define a third bank as indicated by fine slanted shading, and the subarrays 612A through 612H define a fourth bank as indicated by coarse slanted shading.

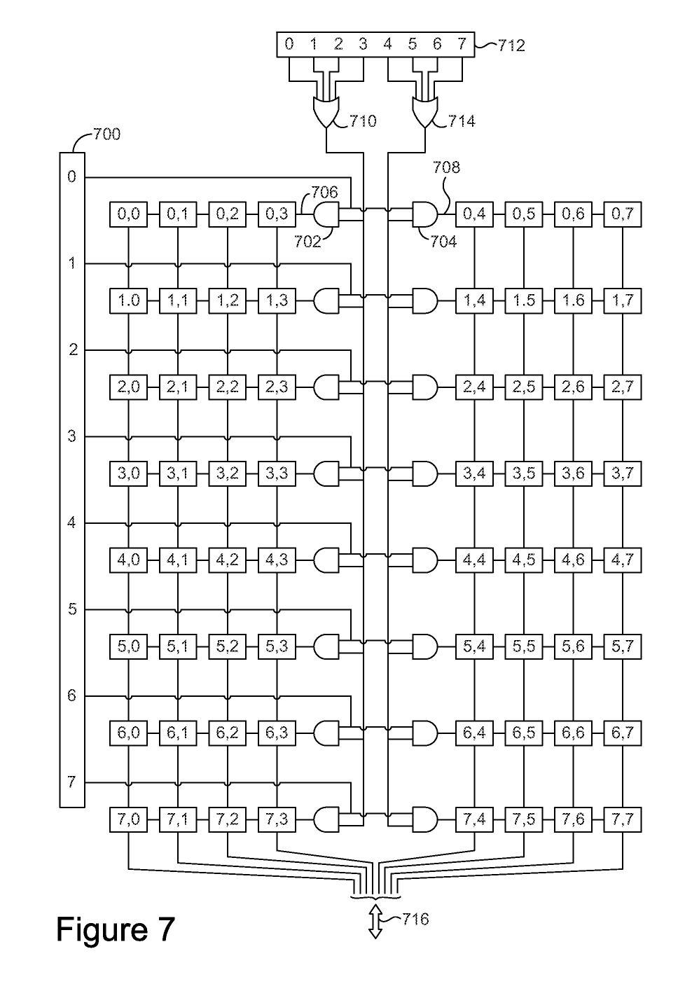

Each subarray comprises a plurality of individual memory cells. For example, the subarray 606A comprises eight sets of memory cells, collectively designated as 614 in FIG. 6B. Each set of memory cells may be configured in 8,192 rows (row 0through row 8,191) by 65,536 columns (column 0 through column 65,535). A wordline is connected to all the cells in each row (except as the wordlines may be modified as discussed below in connection with the example of FIG. 7). A row decoder 616 receives an address from a memory controller and activates corresponding wordlines in each set of memory cells, as indicated by an arrow 618. Similarly, a bitline is connected to all the cells in each column. A column decoder 620 receives the address from the memory controller and enables sense amplifiers (not shown) connected to corresponding bitlines in each set of memory cells, as indicated by an arrow 622, for reading or writing as desired.

Other examples may include different numbers of memory cells, more or timer of the various elements than in this example, and in some examples, some elements may be absent or still others may be present.

As shown in FIG. 6A, the DIMM 600 is in communication with a memory controller 624 as indicated by an arrow 626. The memory controller 624 may be in a CPU as in the example of FIG. 3, separate from a CPU as in the example of FIG. 4, or as discussed above in connection with FIG. 5, it may be physically included in the DIIMM 600 itself. The memory controller 624, responsive to an MFW instruction 628, fixes a quantity of the memory chips that will be activated in response to memory access requests. Any one memory access request is directed to only one of the four banks 606A-H through 612A-H, and therefore only one subarray in any one memory chip is activated at any one time. A designation of a certain number of chips to be activated in response to a memory access request is thus equivalent to designating that number of subarrays.

In the example of FIGS. 6A and 6B, an “MFW=4” instruction has designated “4” as the number of subarrays to be accessed. When a memory access request arrives, the memory controller 624 identifies and selects those four subarrays which contain the requested item. For example, in response to a request for a certain item of data the memory controller, 624 might determine that the requested item is contained in the bank 606A through 606H, and more particularly in the four memory chips 604A-604D. As indicated by a brace 630, the memory controller 624 activates those four memory chips 604A-604D; within the chip 604A, the memory controller 624 activates the subarray 606A, within the chip 604B the memory controller 624 activates the subarray 606B, within the chip 604C, the memory controller 624 activates the subarray 606C, and within the chip 604D, the memory controller 624 activates the subarray 606D.

In some examples, the MFW may include a block size W as well as a number of memory chips to be accessed. In the example of FIGS. 6A and 613, an MFW has specified 4 as the number of chips to be activated and 16 as the block size W. This would result in 16 bytes being accessed in each of four memory chips, or 64 bytes in all.

In some examples, data are transferred between memory cells and row buffers, This is shown in FIG. 6B, where a row buffir 632A receives data from and provides data to the subarray 606A, and similarly row buffers 632B, 632C, and 632D operate with the subarrays 606B, 606C, and 606D, respectively. Since the block size in this example is 16, in a read operation 64 bytes of data may be transferred in 1.6-byte portions from each of rows 634A, 634B, 634C, and 634D to the corresponding row buffers 632A through 632D as indicated by arrows 636A through 636D connecting those rows with their row buffers. The buffers in turn communicate the data to the memory controller 624 as indicated by arrows 638A through 638D, respectively, which represent 8 bits of data flowing from each subarray to the memory controller 624. Since there are 16 bytes to be communicated from each subarray, and each byte has 8 bits, a total of 16 cycles will be required to transfer the 16 bytes from each subarray to the memory controller 624. Four chips are transferring their data, each using 8 bits, so in those 16 cycles a total of 64 bytes will be transferred.

In other examples, larger or smaller block sizes may be specified and more or fewer chips may be specified for activation in response to a memory access request. All eight of the chips are capable of transferring data simultaneously, with each chip transferred eight bits at a time and using 8 out of 64 data lines in the data bus, so two or more different items of data can be read or written at the same time to different sets of chips; for example, if the MFW sets 2 as the number of chips to be activated in response to a memory access request, 4 different access requests can be serviced simultaneously.

The data are transferred from the bus lines to the requestor. If the requestor has a cache memory, the data will be transferred to a line in the cache. Depending on the MFW value, multiple cache lines may be serviced simultaneously or sequentially as discussed above.

In some examples, the MFW may be stored in a memory (e.g., non-volatile memory) or other firmware and is read into the memory controller when the system boots. The overhead involved in setting or changing an MFW is relatively large, and therefore in some examples the MFW cannot be changed (except by reprogramming the firmware). In other examples, a virtual machine may provide a different MEW when it starts, because the high overhead of changing the MFW can be tolerated during start-up.

In some examples, only portions of rows in the subarrays are activated at one time, thereby further reducing power consumption. FIG. 7 provides an example of logic that may be used to activate only desired portions of rows. In this example, there are eight rows 0 through 7 and eight columns 0 through 7. In other examples, there may be different numbers of rows and columns, and the number of rows may be different than the number of columns. Each memory cell is designated by its row and column address; for example, the memory cell located at the crossing of row 1 and column 2 is designated as [1,2],

A row decoder 700 receives addresses from the memory controller and decodes each address to activate a wordline corresponding with the row that is being addressed. For example, if a given address is directed to row 3, a wordline connecting all the cells 3,0 through 3,7 would be activated. However, in this example the row decoder 700 does not directly connect to the wordlines. Instead, the row decoder 700 connects to logic elements that in turn are connected to portions of the wordlines.

For example, the “row 0” output from the row decoder 700, which would indicate that row 0 should be activated, actually connects to AND gates 702 and 704. The AND gate 702 in turn drives a portion 706 of the row 0 wordline that connects to the memory cells 0,0 through 0,3, and the AND gate 704 drives a portion 708 of the row 0 wordline that connects to the memory cells 0,4 through 0,7. Thus, only one portion of the wordline is activated at one time, thereby reducing the amount of energy consumed by activating wordlines.

The AND gate 702 is driven by an OR gate 710 that in turn receives, as inputs, column 0 through column 3 outputs of a column decoder 712. If one of those four columns is being accessed, then the OR gate 710 enables the AND gate 702, and if row 0 is then being activated, the portion of the row 0 wordline that is connected to the AND gate 702 is activated. Other AND gates connected to corresponding portions of the wordlines for rows 1 through 7 perform a similar function. In like manner, the AND gate 704 is driven by an OR gate 714 that receives, as inputs, column 4 through column 7 outputs of the column decoder 712. Only if one of those columns is being accessed does the OR gate 714 enable the AND gate 704 and other AND gates connected to corresponding portions of the row 1 through row 7 wordlines. Bitlines for the columns 0 through 7 communicate with their corresponding memory cells and with a row buffer such as one of the row buffers 632A through 632D as indicated by an arrow 716.

By means of this logic, only a small number of cells in a row are activated in response to any one memory access request, depending on which columns are activated, thereby using less energy that would be required if an entire row of memory cells were activated in response to a row selection from the row decoder. Timing of the row and column select signals may be controlled so that both signals arrive at their respective decoders at the same time.

In other examples, different block sizes may be used in different subarrays, that is, different numbers of columns may be accessed in different subarrays, so long as the total number of columns being accessed satisfies the MFW. For example, if the MFW is set to 2 and the block size is set to 32 bytes, then the memory controller could activate various numbers of arrays and various numbers of columns within those arrays so long as 64 bytes (256 bits) are actually accessed. The total number of activated columns might always be the same, or it might be different depending on the MFW. In this way, the MFW, determines not only how many memory chips will be activated in response to an access request, but also how many columns in those chips will be activated, thereby controlling transfer latency and amount of activation energy needed to respond to any access request.

In some examples, more or fewer logic gates may be used to determine how large a portion of a row to activate, and in some examples such logic may be omitted such that entire rows in selected chips are activated in response to memory access requests.

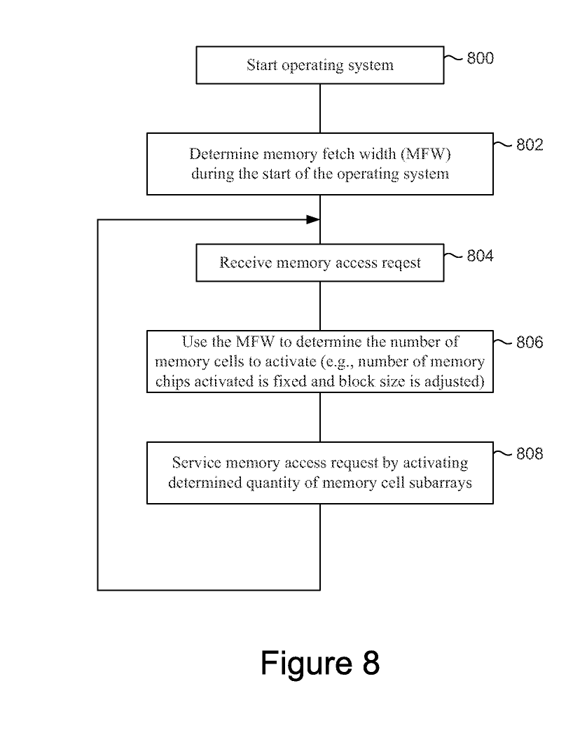

FIG. 8 provides an example of a method of operating a memory with multiple-subarray access. The method includes starting an operating system (800), determining a memory fetch width (“MFW”) during the start of the operating system (802), receiving a memory access request (804), using the MFW to determine the number of memory cells to activate, where the number of memory chips activated is fixed but the block size is adjusted (806), and servicing the memory access request by activating the determined quantity of memory cell subarrays (808).

In some examples, the MFW is determined by retrieving it from permanent storage, for example a non-volatile memory. In other examples, the MFW is determined by the operating, system at initial start-up or when a virtual machine is started.

In some examples, starting the operating system comprises loading operating system instructions into memory during any of activation of a computer system and activation of a virtual machine in the computer system.

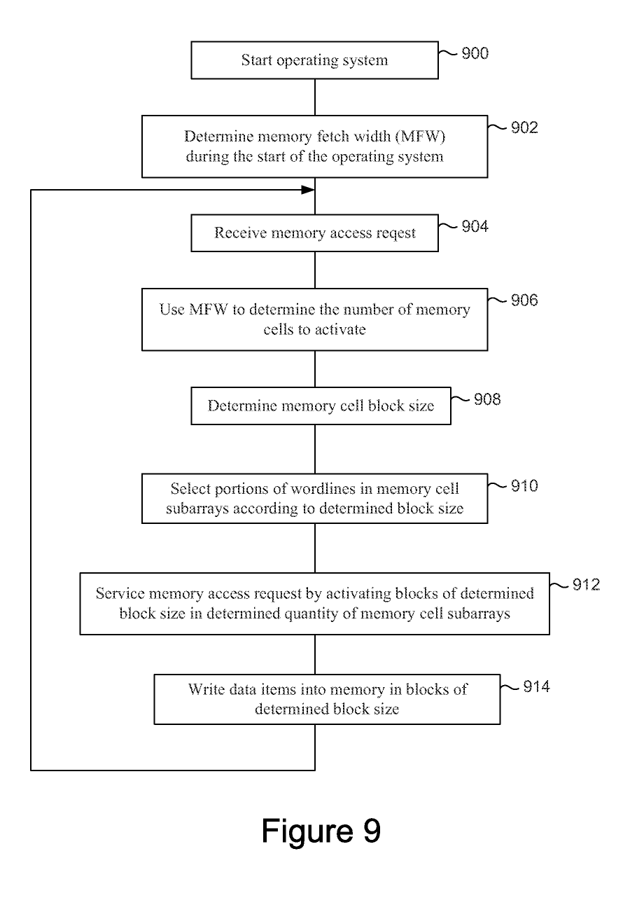

FIG. 9 provides another example of a method of operating a memory with multiple-subarray access. The method includes starting an operating system (900), determining a memory fetch width (“MFW”) during the start of the operating system (902), receiving a memory access request (904), using the MFW to determine how many memory cell subarrays to access in response to the memory access request (906), determining a size of a block of memory cells to be activated within each memory cell subarray in response to memory access requests (908), selecting portions of wordlines in the subarrays according to the determined block size and activating the selected portions of the wordlines (910), and servicing the memory access request by activating blocks of the determined block size in the determined quantity of memory cell subarrays (912). Some examples also include writing items of data into the memory in blocks of the determined block size (914).

Using multiple subarray access can dramatically reduce the amount of energy used to access memories such as DRAMs in servers. In some servers, memory access can consume 30 to 40 percent of total system power, and in large server farms a substantial reduction in the power used to access DRAMs can result in a substantial cost saving as well as reducing environmental impact. The memory system can adapt to requirements of various workloads by changing MFWs at start-up of applications and virtual machines. Memory accesses may actually be faster, despite using less power, than full-page or single-array accesses, and the memory controller design is much simpler than has been required by some other dynamic schemes in which memory access sizes are being changed constantly.

What is claimed is:

1. A multiple subarray-access memory system comprising:
a plurality of memory chips each including a plurality of subarrays; and
a memory controller in communication with the plurality of memory chips, the memory controller to receive a memory fetch width (“MFW”) instruction during an operating system start-up and responsive to the MFW instruction, to fix a quantity of the subarrays that will be activated in response to memory access requests.

2. The memory system of claim 1, wherein the MFW instruction includes a block parameter, the memory controller responsive to the block parameter to fix a size of a block to be activated within each subarray in response to memory access requests.

3. The memory system of claim 1, further comprising a non-volatile memory that contains the MFW instruction.

4. The memory system of claim 1, further comprising logic elements responsive to column decoders to select portions of word lines for activation.

5. The memory system of claim 1, wherein an operating system start-up occurs at any of activation of a computer system and activation of a virtual machine in a computer system.

6. A computer system with multiple subarray-access memory, the system comprising:
a central processor;
a non-volatile memory;
a memory module containing a plurality of memory chips each including a plurality of subarrays; and
a memory controller to receive a memory fetch width (“MFW”) instruction from the non-volatile memory during start-up of the computer system and responsive to the MFW instruction to fix a quantity of the subarrays that will be accessed in response to memory access requests from the central processor.

7. The computer system of claim 6, wherein the MFW instruction includes a block parameter, the memory controller responsive to the block parameter to fix a size of a block to be activated within each subarray in response to memory access requests.

8. The computer system of claim 6, wherein the memory module comprises logic elements responsive to column decoders to select portions of word lines for activation.

9. The computer system of claim 6, wherein the memory controller receives an MFW instruction from the central processor during start-up of a virtual machine in the computer system.

10. A method of operating a memory with multiple sub-array access, the method comprising:
starting an operating system;
determining a memory fetch width (MFW) during the start of the operating system;
receiving a memory access request;
using the MFW to determine how many memory cell subarrays to activate in response to the memory access request; and
servicing the memory access request by activating the determined quantity of memory cell subarrays.

11. The method of claim 10, wherein determining the MFW comprises retrieving a permanently-stored MFW.

12. The method of claim 10, wherein starting the operating system comprises loading operating system instructions into memory during any of activation of a computer system and activation of a virtual machine in the computer system.

13. The method of claim 10, further comprising determining a size of a block of memory cells to be activated within each memory cell subarray in response to memory access requests.

14. The method of claim 13, further comprising writing a plurality of items of data into the memory in blocks of the determined block size.

15. The method of claim 13, wherein activating the determined quantity of memory cell subarrays comprises selecting portions of wordlines in the subways according to the determined block size and activating the selected portions.
